(19) United States
(12) Patent Application Publication
(10) Pub. No.: US 2008/0003847 A1
(43) Pub. Date: Jan. 3, 2008

(54) PLUG-IN CONNECTOR

(75) Inventor: Juergen Lappoehn, Gammelshausen (DE)

Correspondence Address: DARBY & DARBY P.C., P.O. BOX 770, Church Street Station, New York, NY, 10008-0770, US

(73) Assignee: ERNI Elektro-Apparate GmbH, Adelberg (DE)

(21) Appl. No.: 11/548,100

(22) Filed: Oct. 10, 2006

(30) Foreign Application Priority Data
Jun. 30, 2006 (DE) 102006030712.7

(51) Int. Cl. H01R 12/00

(52) U.S. Cl. 439/74

(57) ABSTRACT

The invention relates to a plug-in connector having a first connector housing part in which contact elements are provided whose rear contact element end pieces are prepared for being soldered to a board, at least over a partial area, where, in the mounted condition, the first connector housing part is arranged relative to the board in such a way that the plug-in direction comes to lie in a plug-in plane extending in parallel to the plane of the board. All rear contact element end pieces are arranged on the side to be placed on the board in one plane of the contact element end pieces which extends in parallel to the plane of the board, at least approximately. The plug-in connector according to the invention is particularly well suited for implementing a circular connector, which is arranged in part in the area in front of the board and which permits a sealed plug-and-socket connection to be realized for application in sensor technology.

### PRIOR ART

The present invention relates to a plug-in connector according to the preamble of the independent claim.

U.S. Pat. No. 6,305,975 B1 describes an electric plug-and-socket connection establishing a connection between a board arranged in a vacuum with the components arranged outside thereof. A ridge connected with the board extends into a sealing element of circular cross-section. Inside the sealing element, the ridge assumes the shape of a terminal board. The terminal board is soldered, via conductor elements bent off at a right angle, to an outer terminal board that extends substantially in vertical direction relative to the terminal board on which is arranged a push-on terminal strip configured as a connection post.

US 2006/0019512 A1 describes a plug-and-socket connection for medical applications which comprises a sealed circular connector. The housing of the circular connector is prepared for receiving contact elements soldered to a small board which is to be fixed on the rear end of the housing of the circular connector. The contact elements extend substantially at a right angle to the plane of the board so that the plane of the board extends vertically to the plug-in direction. The rear surface of the small board is provided with printed conductors and terminal areas to which components and connection lines can be connected by soldering.

U.S. Pat. No. 6,986,665 B2 describes a right-angle plug where the contact elements, arranged in the bent-off portion of the plug housing, are connected with a board arranged in the straight portion of the plug housing. The contact elements are thereby aligned in substantially perpendicular relation to the board arranged in the plug housing.

U.S. Pat. No. 6,929,487 B1 describes a connector arrangement intended for a sensor with associated electronic signal processing means. The electronic components are arranged on a board located in a plug-and-socket connection. Soldered to the board is a plug-in connector which comprises contact springs into which contact pins of contact elements are fitted that are bent off by 90 degrees. Contact element end pieces opposite the contact pins are likewise configured as contact springs of a further plug-and-socket connection. The plug-in direction of the further plug-and-socket connection lies in a plane that extends substantially in parallel to the plane of the board.

U.S. Pat. No. 4,998,896 A describes a multi-pole plug-in connector, prepared for soldering, which comprises a plurality of contact rows. The contacts can be connected with solder terminals of the board via connection wires that are bent by 90 degrees. The described plug-in connector, and comparable connector types, are usually arranged at the edge of the board and are allow plug-and-socket connections to be established with connection cables arranged, especially, at the rear of devices.

Plug-in connectors having a configuration similar to the kind described in U.S. Pat. No. 4,998,896 A are found especially at the rear of computers, or at the rear of consumer electronics units.

Now, it is the object of the present invention to provide a plug-in connector that can be arranged on a board and whose plug-in direction lies in a plane extending essentially in parallel to the plane of the board. Further, the plug-in connector should be capable of being sealed.

This object is achieved by the features defined in the independent claim.

### DISCLOSURE OF THE INVENTION

The plug-in connector according to the invention proceeds from a first connector housing part in which contact elements are provided whose contact element end pieces are prepared for being soldered to a board, at least in part. In the mounted condition, the first connector housing part is arranged relative to the board in such a way that the plug-in direction comes to lie in a plane extending in parallel to the plane of the board, at least approximately. On the side that will be supported on the board, all rear contact element end pieces are arranged in a plane of the contact element end pieces, extending in parallel to the plane of the board.

The configuration according to the invention allows the rear contact element end pieces, located in the plane of the contact element end pieces, to be in contact with the board surface in the mounted condition of the plug-in connector so that all contact element end pieces can be soldered simultaneously. Further, the plug-in connector is thereby firmly supported on the board.

It is an essential advantage of the plug-in connector according to the invention that any desired arrangement of the forward contact element end pieces in the first connector housing part can be specified. Especially, a circular connector can re realized as well as a rectangular connector.

The plug-in connector according to the invention is particularly well suited for SMD component mounting. Component mounting can be effected fully-automatically using a commercially available automatic component mounting device so that substantial cost advantages can be achieved in series production. The elimination of manual operations leads to high process safety.

Advantageous further developments and embodiments of a plug-in connector according to the invention are defined in dependent claims.

According to one advantageous embodiment, the rear contact element end pieces are flattened at least in the partial areas intended for soldering. The flattened portions permit the plug-in connector according to the invention to be located in a simple and safe way during mounting and ensure a firm connection after soldering. Further, the flattened portions allow a firm solder joint to be achieved with only a small quantity of paste solder, with low contact resistance of the joint.

According to an especially advantageous embodiment, the first connector housing part is located adjacent the outer edge of the board in the mounted condition of the plug-in connector. That embodiment provides ample freedom with respect to the installation of the plug-in connector according to the invention, for example in a housing of an electronic device.

The embodiment of the plug-in connector envisaged by the invention very advantageously permits the plug-in connector to be implemented as a circular connector. Such a circular connector is intended, especially, for establishing a plug-and-socket connection with sensors.

The configuration as circular connector permits production of plijg-and-socket connections that can be reliably sealed—a requirement which frequently has to be met in sensor technology. Especially efficient sealing is achieved with an embodiment that comprises a sealing ring which on the one hand can be easily arranged on a first connector housing part configured as a circular connector, while on the other hand its rotationally symmetric arrangement allows especially efficient sealing to be achieved.

The embodiment described above, where the first connector housing part comes to lie adjacent the outside of the board in the mounted condition of the plug-in connector, may be selected especially when the plug-in connector is configured as a circular connector. According to one embodiment, the circular connector is then arranged relative to the board in such a way that the plane of the board comes to lie, at least approximately, in the region of the diameter of the circular connector.

According to a different embodiment, a second rear connector housing part is integrally formed on the first connector housing part for accommodating at least part of the rear contact element end pieces.

According to an convenient embodiment, a strain-relief plate is arranged in the area of the second rear connector housing part. If desired, the strain-relief plate may be provided with at least one recess which is engaged by the second connector housing part in the mounted condition of the strain-relief plate, whereby the strain-relief plate is anchored on the second rear connector housing part.

The strain-relief plate preferably is provided with at least one centering pin which in the mounted condition of the plug-in connector passes through an opening in the board thereby anchoring the plug-in connector on the board. At least one centering pin may be configured as a locking hook that engages behind the board in the mounted condition of the plug-in connector.

Preferably, the strain-relief plate comprises at least one recess in the area intended for soldering of the rear contact element end pieces, the recess allowing air to circulate. This reduces the temperature load on the plug-in connector according to the invention during SMD soldering.

One embodiment of the plug-in connector according to the invention is illustrated in the drawing and will be described hereafter in more detail.

In the drawings:

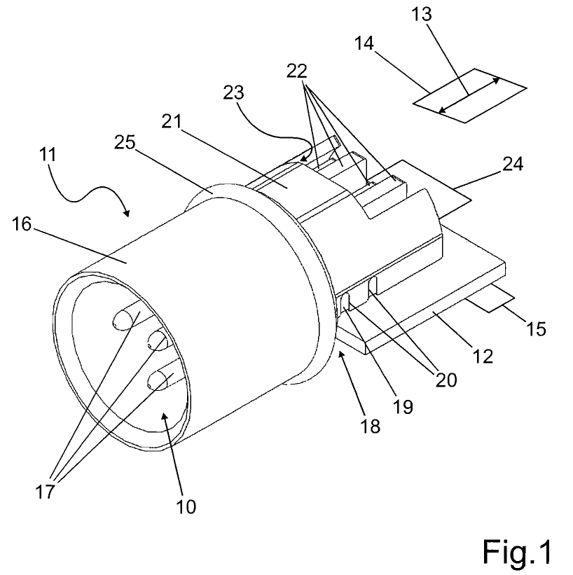

FIG. 1 shows a perspective view of a connection side of a plug-in connector according to the invention, arranged on a board;

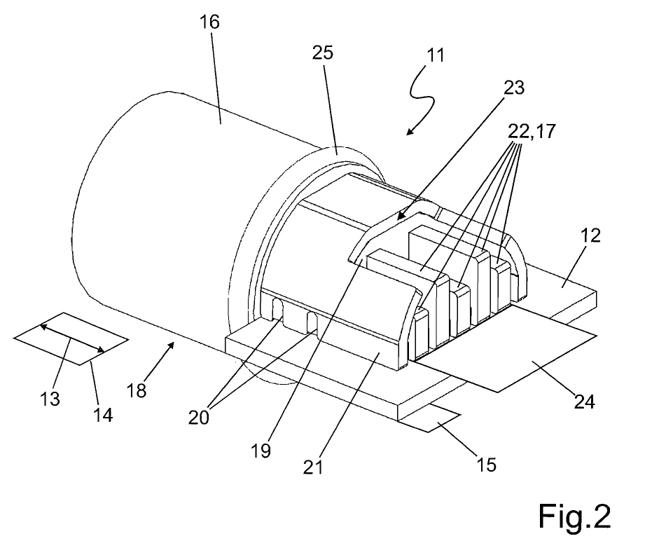

FIG. 2 shows a perspective view of rear contact element end pieces of a plug-in connector according to the invention, arranged on a board;

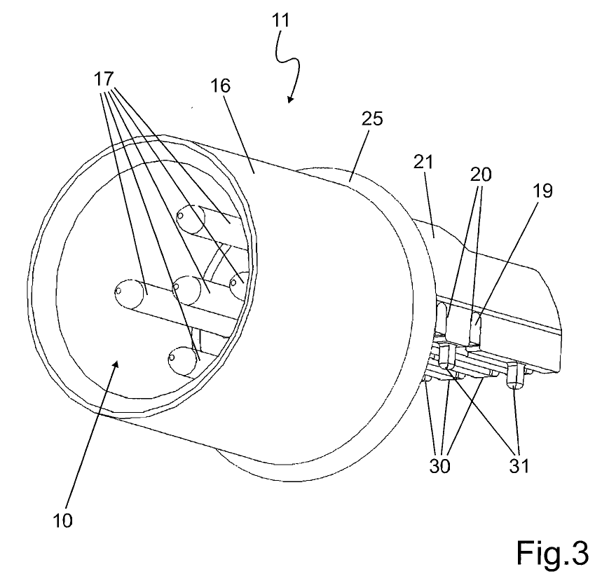

FIG. 3 shows a perspective view of a connection side of a plug-in connector according to the invention, prior to being arranged on a board;

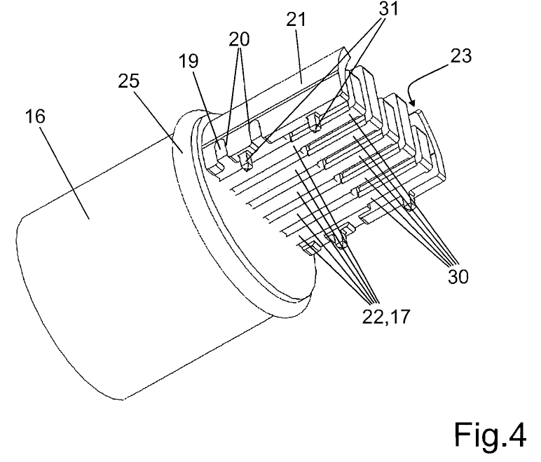

FIG. 4 shows a perspective view of contact element end pieces of a plug-in connector according to the invention, arranged on a board;

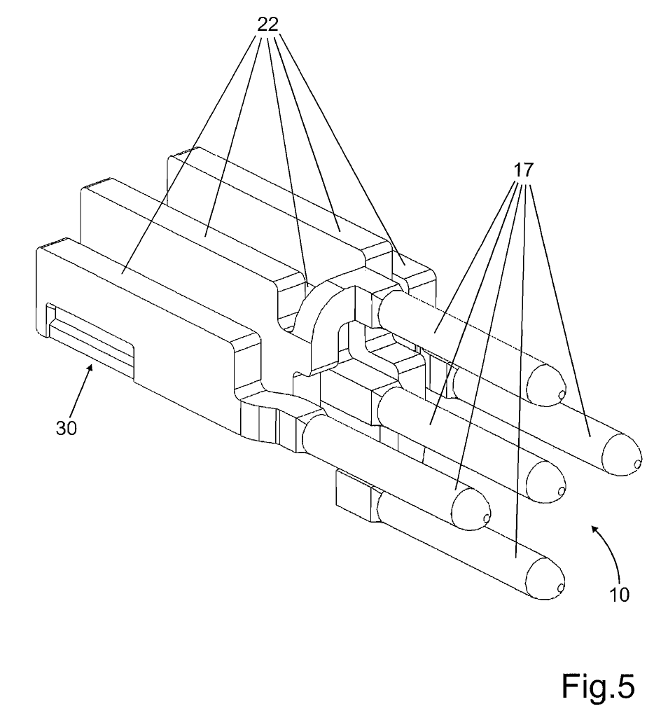

FIG. 5 shows a perspective view of a connection side of contact elements; and

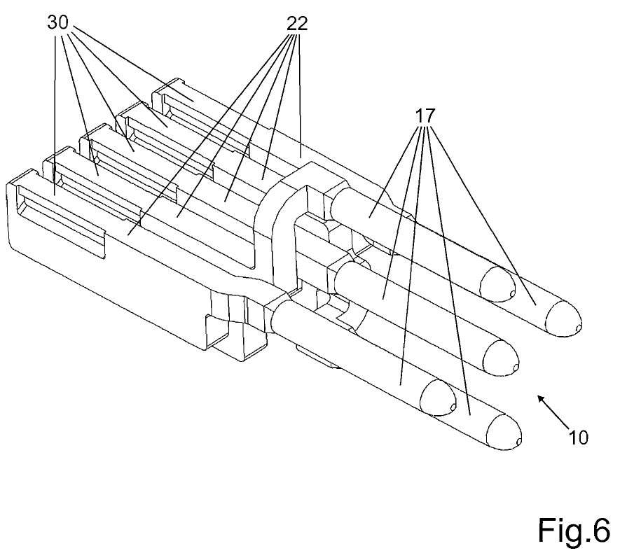

FIG. 6 shows a perspective view according to FIG. 5, but rotated by 180 degrees, in which the areas of rear contact element end pieces intended to be placed on the board can be seen.

FIG. 1 shows a perspective view of the connection side 10 of a plug-in connector 11, placed on a board 12.

The plug-in direction 13 of the plug-in connector 11 extends in a plug-in plane 14, which extends in parallel, at least approximately, to the plane 15 of the board. Accordingly, the plug-in connector that corresponds to the plug-in connector 11, not shown in detail in FIG. 1, is plugged in along a direction 13. In the case of this arrangement, the board 12 can be positioned in a housing of an electronic device, not shown in detail, in horizontal or vertical orientation, for example, and the plug-in connector 11 can be located at the rear or at the top, for example, in an opening of the housing of the electronic device.

The plug-in connector 11 comprises a first connector housing part 16 in which the forward contact element end pieces of contact elements 17 are arranged. In the illustrated embodiment, the forward contact element end pieces are configured as blade contacts which in the plugged-in condition coact with spring contacts provided in the corresponding plug-in connector—not shown in detail.

In the illustrated embodiment, the first connector housing part 16 is completely located in an area 18 external to the board 12.

Formed integrally on the first connector housing part 16 is a second rear connector housing part 19, of which only those portions can be seen in FIG. 1 that engage into recesses 20 of a strain-relief plate 21. In the illustrated embodiment, two recesses 20 are assumed to exist on one side of the strain-relief plate 21.

The second connector housing part 19 is found in the area of the board 12. The second connector housing part 19 accommodates the rear contact element end pieces 22 of the contact elements 17, the contact element end pieces 22 being visible in FIG. 1 due to the presence of a recess 23 in the strain-relief plate 21.

All rear contact element end pieces 22 are arranged, in the areas in which they are to supported on the board—not visible in FIG. 1, in one plane 24 of the contact element end pieces. The plane 24 of the contact element end pieces therefore extends in parallel to the plane 15 of the board and to the plane 14 of the plug-in direction, respectively, at least approximately.

In principle, the first connector housing part 16 may have any desired shape. An especially convenient configuration of a circular connector is illustrated in FIG. 1.

Such a circular connector generally can be sealed from environmental influences by simple measures. In the illustrated embodiments, sealing is achieved by means of a sealing ring 25 provided at the rear end of the first connector housing part 16. Such a circular connector is widely used in sensor technology. It is suited for cabling with a preferably shielded round cable which can be produced at low cost.

The way of proceeding proposed by the invention, where all rear contact element end pieces 22 lie in the same plane 24 of the contact element end pieces, permits an almost unlimited choice of arrangements of the contact elements 17 in the first connector housing part 16, in spite of the limited space available in a circular connector, so that a multi-pole connector can be implemented in a comparatively small space.

An especially advantageous solution is achieved by the illustrated embodiment in which the first connector housing part 16 is located in the area 18 in front of the board 12 relative to the plane 15 of the board in which case the plane 15 of the board comes to lie, at least approximately, in the region of the greatest extension of the first connector housing part 16. In this case, the largest possible space is available in the second connector housing part 19 for accommodating the rear contact element end pieces 22.

FIG. 2 shows a perspective view of the rear contact element end pieces 22 with the plug-in connector 11 placed on the board 12. Those parts of FIG. 2 that correspond to parts illustrated in FIG. 1 are designated by the same reference numerals. In FIG. 2, all rear contact element end pieces 22 lying in the plane 24 of the contact element end pieces can be seen. Consequently, 5 contact elements 15 with 5 contact element end pieces 22 are provided in the illustrated embodiment.

FIG. 2 shows with particular clarity that by arranging the contact element end pieces 22 in the plane 24 of the contact element end pieces on the side that is to be placed on the board, an easy way is provided for realizing plug-in connectors 11, especially circular connectors that have the first connector housing part 16 arranged in an area 18 in front of the board 12.

The recesses 20 in the strain-relief plate 21 support the process of soldering the rear contact element end pieces 22 to a printed conductor structure on the board 12—not shown in detail—using the SMD technique. The recess 23 favors the circulation of hot air during the soldering process thereby preventing over-heating especially of the second connector housing part 19 which generally is less heat-resistant than the contact elements 17 and the strain-relief plate 21.

In the perspective view of the connection side 10 in FIG. 3, all 5 contact elements 17 of the plug-in connector 11 can be seen at least in part. Again, parts corresponding to similar parts in the preceding Figures are designated by the same reference numerals.

Further, FIG. 3 provides a view of partial areas 30 of the rear contact element end pieces 22 that are to be connected by soldering. As can be seen already in FIG. 3, at least the partial areas 30 that are to be soldered are flattened in one embodiment. The flattened portions allow a large area contact between the partial areas 30 and the printed conductor structure on the board 12 thereby contributing not only to a firm connection but also to a low contact resistance of the SMD solder joint.

FIG. 3 shows two centering pins 31 that may be arranged on a lateral portion of the strain-relief plate 21. The centering pins 31 engage in corresponding openings in the board 12 thereby supporting the mechanical stability, especially prior to soldering of the plug-in connector 11. If desired, at least one centering pin 31 may be configured as a locking hook that engages behind the board 12 when the board is mounted on the plug-in connector 11.

FIG. 4 shows a perspective view of the rear contact element end pieces 22 of the plug-in connector 11. Parts similar to those described above are again designated by the same reference numerals.

FIG. 4 especially provides a view of the second connector housing part 19 in which the rear contact element end pieces 22 of the contact elements 17 are arranged at least in part. The second connector housing part 19 ends at least approximately at the point where the partial area 30, intended for soldering, of the rear contact element end pieces 22 begins so that the second connector housing part 19, which generally is made from a plastic material, will not be thermally overloaded.

FIG. 4 illustrates an embodiment where the rear contact element end pieces 22 are flattened not only in the partial areas 30, where they are to be soldered, but rather over the entire areas intended to be supported on the board 12. The advantages resulting from that configuration have already been described before.

FIG. 5 shows a perspective view from the connection side 10 of the contact elements 17. Parts identical to those illustrated in the preceding Figures are again designated by the same reference numerals. The illustration only shows the contact elements 17, without the housing parts 16, 19. It can be seen in FIG. 5 how the transition between the forward contact element end pieces and the rear contact element end pieces 22 can be realized by cranking and bending of the contact elements 17. It is possible in this way, especially if the plug-in connector 11 according to the invention is configured as a circular connector, to realize practically any desired arrangement of the contact elements 17 in accordance with specifications provided.

FIG. 6 shows a perspective view similar to that of FIG. 5, but rotated by 180 degrees, which provides a view of the flattened rear contact element end pieces 22 with the partial areas 30 of the contact elements 17 intended for soldering.

1. A plug-in connector having a first connector housing part in which contact elements are provided whose rear contact element end pieces are prepared for being soldered to a board, at least over a partial area, where, in the mounted condition, the first connector housing part is arranged relative to the board in such a way that the plug-in direction comes to lie in a plug-in plane extending in parallel to the plane of the board, wherein all rear contact element end pieces are arranged on the side to be placed on the board in one plane of the contact element end pieces and that the plane of the contact element end pieces extends in parallel to the plane of the board.

2. The plug-in connector according to claim 1, wherein at least those partial areas of the rear contact element end pieces of the contact elements are flattened which are intended for soldering.

3. The plug-in connector according to claim 1, wherein the rear contact element end pieces of the contact elements, which are intended for being placed on the board, are flattened over their entire area.

4. The plug-in connector according to claim 1, wherein the first connector housing part is located in an area in front of the board and adjacent the board in the mounted condition of the plug-in connector.

5. The plug-in connector according to claim 1, wherein the plug-in connector is configured as a circular connector.

6. The plug-in connector according to claims 4, wherein in the mounted condition of the plug-in connector the first connector housing part of the plug-in connector configured as a circular connector is arranged relative to the board so that the board comes to lie in the region of the diameter of the circular connector.

7. The plug-in connector according to claim 5, wherein the first connector housing part comprises a sealing ring.

8. The plug-in connector according to claim 1, wherein a second rear connector housing part is integrally formed on the first connector housing part for accommodating at least part of the rear contact element end pieces.

9. The plug-in connector according to claim 8, wherein a strain-relief plate is arranged in the area of the second rear connector housing part.

10. The plug-in connector according to claim 9, wherein the strain-relief plate comprises at least one recess which is engaged by the second connector housing part in the mounted condition of the strain-relief plate.

11. The plug-in connector according to claim 9, wherein the strain-relief plate is provided with at least one centering pin which in the mounted condition of the plug-in connector passes through an opening in the board.

12. The plug-in connector according to claim 9, wherein the strain-relief plate comprises at least one recess at least in the partial areas of the rear contact element end pieces intended for soldering, which recess allows air to circulate.
